(19) United States
(12) Patent Application Publication
(10) Pub. No.: US 2020/0391059 A1
(43) Pub. Date: Dec. 17, 2020

(54) CONTROL SYSTEM FOR USE DURING TUNNEL FIRE

(71) Applicant: NEC CORPORATION, Tokyo (JP)

(72) Inventor: Akihiro TANAKA, Tokyo (JP)

(73) Assignee: NEC CORPORATION, Tokyo (JP)

(21) Appl. No.: 16/772,029

(22) PCT Filed: Oct. 19, 2018
(86) PCT No.: PCT/JP2018/039047

§ 371 Date: Jun. 11, 2020

(30) Foreign Application Priority Data
Dec. 12, 2017 (JP) 2017-237849

(51) Int. Cl. A62C 3/02; E21F 1/00; G08B 17/103; A62C 37/36

(52) U.S. Cl. CPC A62C 3/0207; A62C 3/0221; A62C 37/36; E21F 1/00; G08B 17/103; A62C 3/0271

(57) ABSTRACT

A control system for use during a tunnel fire includes: measurement means 100₁ to 100ₙ installed in each of a plurality of management sections assigned in a tunnel, and for measuring one or both of a gas concentration and a smoke concentration in the management section using a light signal; and control means 102 for identifying a management section which includes a fire point, and controlling blowing means 101 capable of changing an air volume, based on one or both of the gas concentration and the smoke concentration measured by one or more measurement means installed in one or more management sections located downstream of the identified management section.

### TECHNICAL FIELD

The present invention relates to a control system for use in stopping damages by a fire when the fire breaks out inside a tunnel.

### BACKGROUND ART

Effective use of land has been promoted in urban areas. For expressways, use of underground space has been actively promoted in combination with the worsening problem of traffic jams in urban areas. This has increased the ratio of tunnel structures on expressways in urban areas. In Japan, the ratio of tunnel structures in sections already in service on metropolitan expressways was less than 10% whereas the ratio of tunnel structures in sections under construction was 70% in 2010 (refer to Non Patent Literature (NPL) 1).

For tunnels on expressways, warning issuance based on prompt and accurate detection of a fire breakout and evacuation guide equipment for safe evacuation of users are required. Such requirements apply not only to tunnels on expressways but also to tunnels on general roads.

In this description, the term “tunnel” includes not only road or railway tunnels located in mountainous areas or under the sea but also expressways or railways formed in the ground. In other words, the term “tunnel” may be defined as a space formed in the ground and extending long in the longitudinal direction.

It has been reported that about 70% of vehicle fires in Japan are caused by vehicle failures. Typically, when a vehicle failure occurs, a fire does not break out for a while after the vehicle is stopped. Therefore, a road administrator cannot issue a fire warning until a flame is actually visible, even when the road administrator recognizes the stop of the vehicle through a monitoring camera (e.g. closed-circuit television: CCTV). Damage may spread due to an initial response delay.

Fire alarms for detecting infrared radiation from a flame are mainly installed in tunnels in Japan. However, a fire detector can only detect a fire after flame initiation. Hence, an initial response delay cannot be prevented even if a fire detector is installed.

Temperature detectors or smoke detectors are introduced in Europe. However, the reaction speed of a temperature detector is usually not high, and a smoke detector is susceptible to dust other than smoke. Thus, both detectors have advantages and disadvantages. There is no detector capable of thoroughly responding to various fire breakout scenarios. There is accordingly a need to respond to a wide variety of fire breakout scenarios based on a combination of a plurality of detection parameters.

Patent Literature (PTL) 1 discloses a method of responding to a wider variety of fire breakout scenarios. This method uses an optical gas detection method. In the optical gas detection method, a light signal for measurement propagates in the atmosphere, to measure target gas concentration and smoke concentration in the ambient atmosphere.

FIG. 13 is a block diagram depicting a detection system in an underground space disaster prevention system described in PTL 1, in a simplified form. In a transmitter 131 in the detection system shown in FIG. 13, a light signal output from a light source 1311 is converted into a parallel light beam by a condenser 1313, and then transmitted to a receiver 132. In the receiver 132, the received light signal is condensed by a condenser 1321, and then converted into an electrical signal by a light detector 1323. A signal processing unit 1325 performs predetermined signal processing on the electrical signal, to calculate the average concentration of measurement target gas and the smoke concentration between the transmitter 131 and the receiver 132.

The detection system shown in FIG. 13 simultaneously measures smoke caused by a fire and gas (such as carbon monoxide) that is likely to negatively impact the human body, and issues a fire warning when both measurement values exceed thresholds. This increases the possibility of more reliable fire detection. In addition, since the detection system is configured to propagate the light signal in the atmosphere, a wide area can be monitored by one detection system.

In detection systems, a scheme utilizing the property of a gas molecule absorbing light of specific wavelength is typically used. One example is a scheme of performing gas detection while modulating wavelength using a narrow wavelength band light source for outputting wavelength in the vicinity of absorption wavelength. Another example is a scheme of calculating gas concentration from known spectral intensity using a wide wavelength band light source sufficiently encompassing absorption wavelength. NPL 2 describes wavelength modulation spectroscopy (WMS) as an example of the former scheme. NPL 3 describes differential optical absorption spectroscopy (DOAS) as an example of the latter scheme.

There is a method of controlling a blower such as a jet fan installed in a tunnel to enhance safety when a fire is detected by a fire detector. For example, PTL 2 describes a method of controlling the wind speed in a tunnel based on a wind direction and wind speed value measured by an anemometer and a VI value measured by a VI (visibility index: smoke transmittance) meter. PTL 3 describes a method of controlling wind speed in a tunnel based on traffic ventilation power (ventilation power as a result of vehicle running) when a fire is detected. Specifically, with the method described in PTL 3, the number of vehicles entering the tunnel is counted, the number and average speed of vehicles on the upstream side (on the tunnel entrance side in PTL 3) of a fire point (a point where a fire actually breaks out, i.e. a fire breakout point) and the number and average speed of vehicles on the downstream side (on the tunnel exit side in PTL 3) of the fire point are calculated, and traffic ventilation power is estimated based on the calculated values. PTL 4 describes a method of reducing or zeroing wind speed near a fire breakout point in consideration of start timing of a jet fan located away from the fire breakout point.

PTL 4 describes that the safety of evacuees can be ensured by reducing or zeroing the wind speed near the fire breakout point (see paragraphs 0063 and 0066 in PTL 4). PTL 4 also describes that, by performing ventilation control for normal time in the ventilation section on the downstream side of the fire breakout point, a secondary disaster (e.g. carbon monoxide poisoning as a result of ventilator stopping) which can occur in the downstream ventilation section not influenced by the fire can be suppressed (see paragraphs 0058 and 0059 in PTL 4).

Note that wind speed near a fire breakout point is typically zeroed in a two-way traffic type tunnel that is not one-way.

### CITATION LIST

### Patent Literatures

PTL 1: Japanese Patent Application Laid-Open No. 2005-83876

PTL 2: Japanese Patent Application Laid-Open No. 2000-265799

PTL 3: Japanese Patent No. 3011553

PTL 4: Japanese Patent No. 5813546

### Non Patent Literatures

NPL 1: Masahiko Sasaki, et al., “Technology and Procurement of deep underground tunnels”, the 21st Japan and Korea Construction Technology Seminar”, 2010.
NPL 2: Takaya Iseki, “Trace Gas Detection Technology Using Near Infrared Semiconductor Laser”, Journal of the Society of Mechanical Engineers, Vol. 107, No. 1022, P. 51, 2004.
NPL 3: Hayato Saito, et al., “Measurement of atmospheric carbon dioxide by applying differential absorption spectroscopy in the near infrared region”, the 31st Laser Sensing Symposium D-3, 2013.
NPL 4: R. Mitchell Spearrin, “Mid-Infrared Laser Absorption Spectroscopy For Carbon Oxides in Harsh Environments”, Ph. D. thesis, September 2014.

### SUMMARY OF INVENTION

### Technical Problem

However, reducing or zeroing the wind speed near the fire breakout point may inhibit the evacuation of the occupants (drivers and non-drivers) of vehicles near the fire breakout point. In detail, if the wind speed near the fire breakout point is reduced or zeroed, carbon monoxide gas and smoke poisonous to the human body stay near the fire breakout point and affect the evacuees.

For example, PTL 4 describes that a secondary disaster which can occur in the downstream ventilation section not influenced by the fire can be suppressed. With the method described in PTL 4, based on the influence of the wind speed in each ventilation section other than the ventilation section (fire breakout section) which includes the fire breakout point, a ventilator such as a jet fan in each ventilation section is controlled. However, a measurement value of a measuring instrument installed in each ventilation section is not reflected in the ventilator control. With the method described in PTL 3, wind speed control in the tunnel is performed based on traffic ventilation power when a fire is detected, but a measurement value of a measuring instrument is not reflected in the wind speed control.

The present invention has an object of providing a control system for use during a tunnel fire capable of safely evacuating vehicle occupants using a measurement value of a measuring instrument usable for monitoring the influence of a fire.

### Solution to Problem

A control system for use during a tunnel fire according to the present invention includes measurement means installed in each of a plurality of management sections assigned in a tunnel, and for measuring one or both of a gas concentration and a smoke concentration in the management section using a light signal, and control means for identifying a management section which includes a fire point, and controlling blowing means capable of changing an air volume, based on one or both of the gas concentration and the smoke concentration measured by one or more measurement means installed in one or more management sections located downstream of the identified management section.

A control method for use during a tunnel fire according to the present invention includes measuring, in each of a plurality of management sections assigned in a tunnel, one or both of a gas concentration and a smoke concentration in the management section using a light signal, identifying a management section which includes a fire point, and controlling blowing means capable of changing an air volume, based on one or both of the gas concentration and the smoke concentration measured in one or more management sections located downstream of the identified management section.

### Advantageous Effects of Invention

According to the present invention, it is possible to safely evacuate vehicle occupants.

### BRIEF DESCRIPTION OF DRAWINGS

FIG. 1 is a block diagram depicting an example of an in-tunnel control system including a control system for use in a tunnel fire according to Exemplary Embodiment 1.

FIG. 2 is a block diagram depicting an example of the structure of a long-range sensor.

FIG. 3 is a flowchart depicting the operation of a controller in Exemplary Embodiment 1.

FIG. 4A is an explanatory diagram depicting diffusion situations of gas and smoke when wind speed is changed after a fire breakout.

FIG. 4B is an explanatory diagram depicting diffusion situations of gas and smoke when wind speed is changed after a fire breakout.

FIG. 4C is an explanatory diagram depicting diffusion situations of gas and smoke when wind speed is changed after a fire breakout.

FIG. 5 is an explanatory diagram depicting a result of determining measurement difficulty by numerical simulation.

FIG. 6 is an explanatory diagram depicting an example of emitting light signals of two wavelengths in a time-division manner.

FIG. 7 is a block diagram depicting an example of a transmitter and a receiver realized by a transceiver and a reflector.

FIG. 8 is a block diagram depicting an example of an in-tunnel control system including a control system for use in a tunnel fire according to Exemplary Embodiment 2.

FIG. 9 is a block diagram depicting an example of the structure of a long-range sensor.

FIG. 10 is a flowchart depicting the operation of a controller in Exemplary Embodiment 2.

FIG. 11 is a block diagram depicting main parts of a control system for use in a tunnel fire.

FIG. 12 is a block diagram depicting main parts of a control system for use in a tunnel fire according to another embodiment.

FIG. 13 is a block diagram depicting a detection system in an underground space disaster prevention system described in PTL 1, in a simplified form.

### DESCRIPTION OF EMBODIMENT

Exemplary embodiments of the present invention will be described below, with reference to the drawings.

### Exemplary Embodiment 1

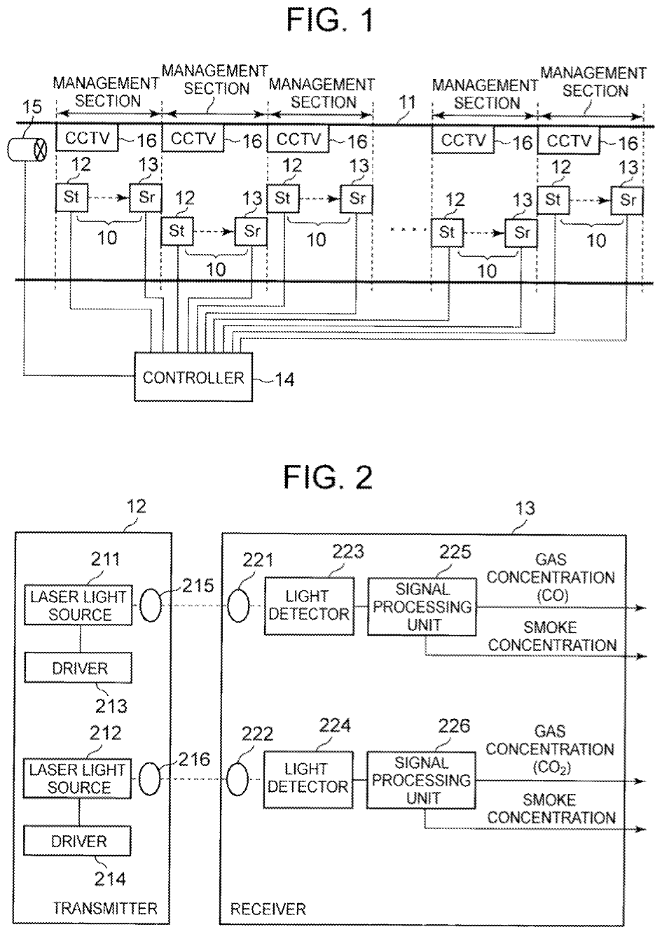

FIG. 1 is a block diagram depicting an example of an in-tunnel control system including a control system for use in a tunnel fire according to Exemplary Embodiment 1.

In a tunnel 11 shown in FIG. 1, a jet fan 15 which is an example of a blower capable of at least changing air volume is installed. The tunnel 11 is divided into a plurality of management sections. A long-range sensor 10 and a monitoring camera 16 are installed in each management section. The long-range sensor 10 is a sensor suitable for long-distance measurement as compared with a short-range sensor used for infrared or Bluetooth®. In this exemplary embodiment, the long-range sensor 10 is composed of a transmitter 12 and a receiver 13 for light signals. The long-range sensor 10 is installed at an upper part of the side wall of the tunnel 11. A measurement value of each long-range sensor 10 is transmitted to a controller 14. The controller 14 uses the measurement values to control the jet fan 15.

FIG. 2 is a block diagram depicting an example of the structure of the long-range sensor 10. In the example of the long-range sensor 10 shown in FIG. 2, the transmitter 12 includes two laser light sources 211 and 212, drivers 213 and 214 for driving the laser light sources 211 and 212, and condensers 215 and 216. The receiver 13 includes two condensers 221 and 222, light detectors 223 and 224, and signal processing units 225 and 226.

Light signals propagate between the transmitter 12 and the receiver 13 in each of the long-range sensors 10 spaced at a predetermined distance inside the tunnel 11. In the receiver 13, the light detectors 223 and 224 that have received light signals via the condensers 221 and 222 photoelectrically convert the light signals, and output the resultant electrical signals to the signal processing units 225 and 226. The signal processing units 225 and 226 each calculate gas concentration and smoke concentration in the management section where the long-range sensor 10 is installed, using the corresponding electrical signal.

The signal processing units 225 and 226 and the controller 14 can be implemented by an electrical circuit (hardware), or implemented by a central processing unit (CPU) that performs processes according to a program.

The operation of the long-range sensor 10 will be described below.

The driver 213 controls the drive current and temperature of the laser light source 211. The laser light source 211 outputs a light signal of a predetermined wavelength (denoted as λ₁ μm). The light signal is converted into parallel light by the condenser 215, and then emitted into the atmosphere. When the light signal reaches the receiver 13, the light signal is condensed by the condenser 221. The light detector 223 photoelectrically converts the condensed light signal into an electrical signal. The signal processing unit 225 calculates the average value of carbon monoxide (CO) concentration between the transmitter 12 and the receiver 13, from the electrical signal.

The driver 214 controls the drive current and temperature of the laser light source 212. The laser light source 212 outputs a light signal of a predetermined wavelength (denoted as λ₂ μm). The light signal is converted into parallel light by the condenser 216, and then emitted into the atmosphere. When the light signal reaches the receiver 13, the light signal is condensed by the condenser 222. The light detector 224 photoelectrically converts the condensed light signal into an electrical signal. The signal processing unit 226 calculates the average value of carbon dioxide (CO₂) concentration between the transmitter 12 and the receiver 13, from the electrical signal.

Moreover, the signal processing units 225 and 226 each calculate smoke concentration Cs from the transmittance of the light signal, according to Formula (1).

Is=Io×e^{-CsD} (1).

In Formula (1), Is is the intensity of the light signal emitted from the transmitter 12, Io is the intensity of the light signal received by the receiver 13, and D is the distance between the transmitter 12 and the receiver 13.

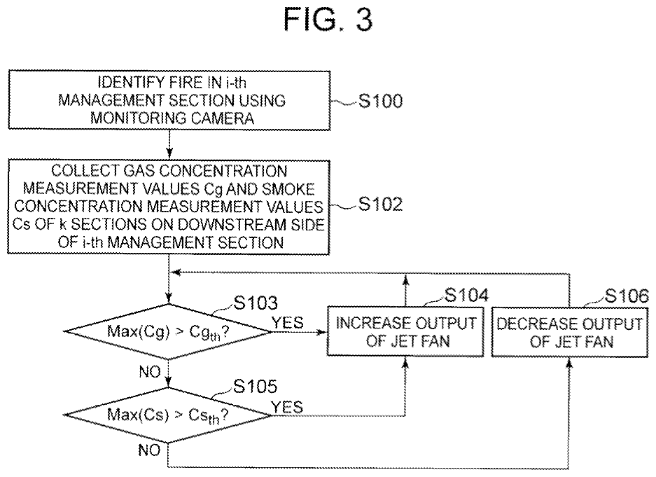

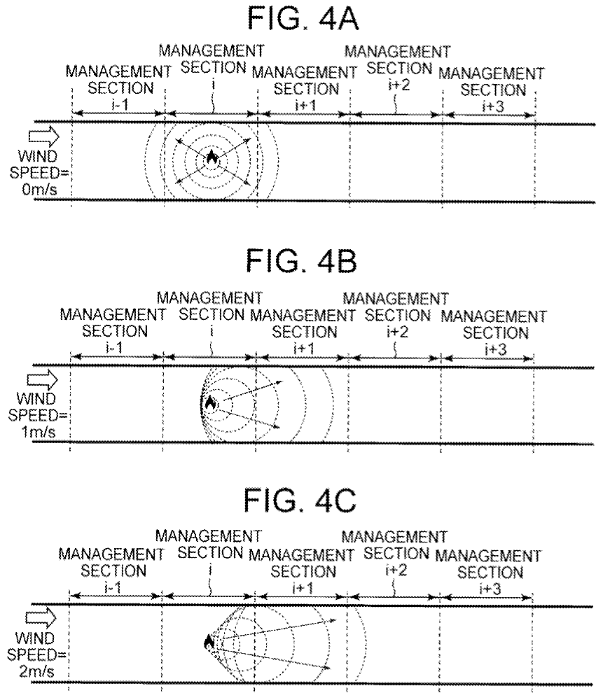

The operation of the controller 14 in Exemplary Embodiment 1 will be described below, with reference to a flowchart in FIG. 3 and an explanatory diagrams in FIGS. 4A-4C. FIGS. 4A-4C are an explanatory diagram depicting diffusion situations of gas and smoke in response to changes in wind speed after a fire breakout. FIGS. 4A-4C illustrate the situations when the tunnel is viewed from above.

When a fire is detected through the monitoring camera 16 installed in the ith management section (management section i) in step S100 (see FIG. 4A), the controller 14 collects the measurement values of gas concentrations (Cg) and smoke concentrations (Cs) of k sections on the downstream side (the wind flow downstream side, i.e. the leeward side) of the ith management section (step S102). In the example shown in FIGS. 4A-4C, k=(i+1) to (i+3).

Here, the fire breakout may be detected by the controller 14 receiving an image (still image or moving image) captured by the monitoring camera 16 and, for example, comparing the captured image with a predetermined reference image. Alternatively, the image captured by the monitoring camera 16 may be transmitted to a device in the in-tunnel system other than the controller 14 so that the device, upon detecting the fire breakout, outputs a signal indicating the fire breakout to the controller 14.

The controller 14 compares the maximum value of the collected CO gas concentrations (Cg) of the k sections with a preset gas concentration threshold Cgₜₕ (e.g. 10 ppm) (step S103). In the case where the maximum value is greater than the threshold, the controller 14 performs control to increase the output of the jet fan 15, in order to diffuse harmful gas (step S104). Specifically, the controller 14 provides a control signal including an instruction to increase the output (air volume), to the jet fan 15.

The controller 14 also compares the maximum value of the collected smoke concentrations (Cs) of the k sections with a preset smoke concentration threshold Csₜₕ (e.g. 0.4 [l/m]) (step S105). In the case where the maximum value is greater than the threshold, the controller 14 performs control to increase the output of the jet fan 15, in order to diffuse smoke (step S104).

In the case where the gas concentration maximum value and the smoke concentration maximum value are each not greater than the threshold, the controller 14 performs control to decrease the output of the jet fan 15 (step S104). Specifically, the controller 14 provides a control signal including an instruction to decrease the output (air volume), to the jet fan 15. Since the output of the jet fan 15 is decreased, the diffusion range of harmful gas and smoke is reduced, and the supply of fresh air to the fire source is suppressed.

In the case where there is a predetermined safety standard, for example, the gas concentration maximum value and the smoke concentration maximum value are set so as to satisfy the safety standard.

Specific examples and effects of the control by the controller 14 will be described below, with reference to FIGS. 4A-4C.

In the case where the wind speed is 0 m/s, the generated gas and smoke spread concentrically from the fire point and reaches the side wall on which the long-range sensor 10 is installed, as shown in FIG. 4A. As the wind speed increases to 1 m/s and 2 m/s, the propagation area of gas and smoke expands to the leeward side.

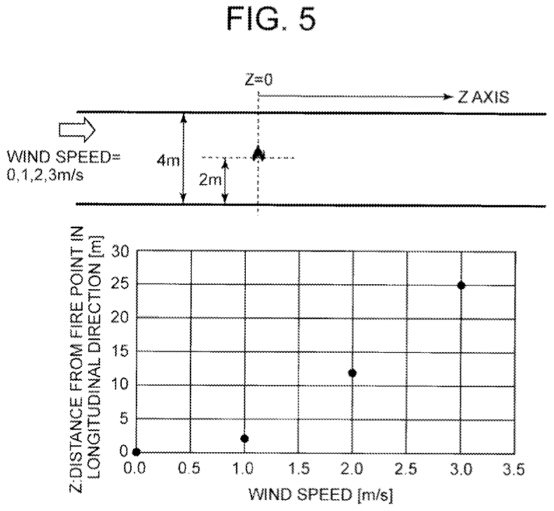

This makes it difficult for the long-range sensor 10 installed on the side wall in the management section including the fire point to accurately measure the gas concentration and the smoke concentration. FIG. 5 is an explanatory diagram depicting a result of determining measurement difficulty by numerical simulation. In the simulation, a fire point was located at the center of a half-cylindrical tunnel with a width of 4 m, and the extent to which CO gas generated from a fire shifted in the tunnel longitudinal direction (Z direction) to reach the side wall was simulated.

As the wind speed increased, the point at which the gas reached the side wall shifted to the downstream side. Under a wind speed condition of 3 m/s, the gas reached the side wall, i.e. the long-range sensor 10, 25 m downstream.

The shift amount changes depending on the position of the fire point and the wind speed. Due to a change of the shift amount, the reliability of the measurement values of gas concentration and smoke concentration in the management section including the fire point (management section i in the example shown in FIGS. 4A-4C) decreases. It is therefore preferable to perform wind speed control based on the measurement values of gas concentration and smoke concentration in the management sections downstream of the fire point.

In the simulation conditions shown in FIG. 5, the shift amount in the Z direction was 25 m at a maximum. Hence, in the case where the length of the management section is 50 m, only one downstream management section needs to be monitored (k=1). In the case where the tunnel width is wider, the fire point is farther from the side wall on which the long-range sensor 10 is installed, or the management section is shorter, the shift amount in the Z direction is greater, so that the number k of management sections to be monitored is increased.

In this exemplary embodiment, the reliability of the sensor for monitoring the influence of the fire can be improved substantially, as a result of which safe evacuation of vehicle occupants near the fire breakout point can be achieved. This is because, while generating sufficient wind power to diffuse harmful gas and smoke which inhibit safe evacuation of occupants, harmful gas and smoke swept away downstream by wind are measured to ensure, for example, that the safety standard is satisfied.

Although the laser light sources 211 and 212 are used as the two light sources in Exemplary Embodiment 1, broadband light sources such as light emitting diodes (LEDs) or super luminescent diodes (SLDs) may be used. Moreover, the gas concentration may be measured by differential optical absorption spectroscopy (DOAS).

A light amplifier may be provided in the output stage of each of the laser light sources 211 and 212 and the input stage of each of the light detectors 223 and 224. The provision of the light amplifier improves the signal-to-noise ratio of the received light signal and improves the accuracy of the measurement result.

Although the structure in which the light signal propagates in one direction in the space between the transmitter 12 and the receiver 13 is used in Exemplary Embodiment 1, one or more mirrors may be provided between the transmitter 12 and the receiver 13. By causing the light signal to reflect off the one or more mirrors, the space propagation path of the light signal can be lengthened. As a result of lengthening the space propagation path of the light signal, target gas of lower concentration can be detected.

Although the two signal processing units 225 and 226 are provided to process light signals of two lines in Exemplary Embodiment 1, the signal processing units 225 and 226 may be integrated into one signal processing unit.

Although each of the light signals of two lines is used to measure the smoke concentration based on the transmittance of the light signal in Exemplary Embodiment 1, only the light signal of one line may be used. The controller 14 may use the average value of the smoke concentrations of the two lines, to improve the accuracy of the measurement value.

Although the gas used for controlling the jet fan 15 is CO and the gas concentration threshold is set to 10 [ppm] as an example in Exemplary Embodiment 1, the threshold may be another value. The controller 14 may use CO₂ gas concentration in addition to CO gas concentration, for the control of the jet fan 15.

Although the smoke concentration threshold is set to 0.4 [l/m] in Exemplary Embodiment 1, the threshold may be another value. Although the controller 14 controls the jet fan 15 by monitoring both CO gas concentration and smoke concentration in Exemplary Embodiment 1, the controller 14 may control the jet fan 15 using any of CO gas concentration and the smoke concentration.

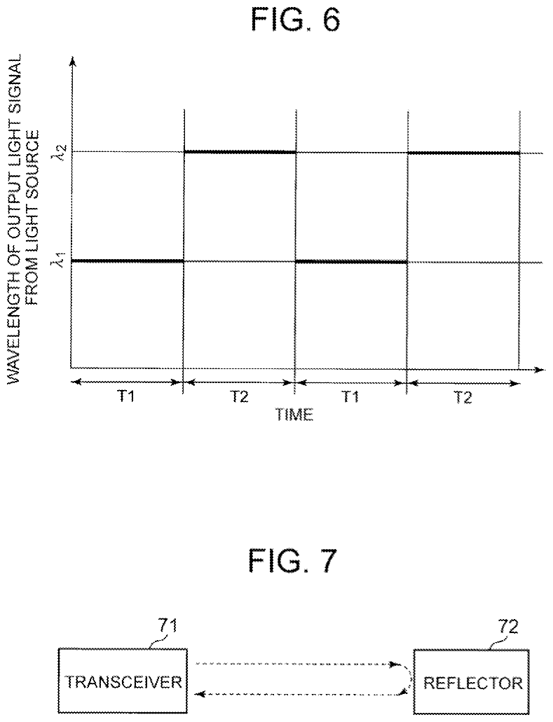

Although two different light sources are used to measure CO gas concentration and CO₂ gas concentration in Exemplary Embodiment 1, one light source may be used. In such a case, for example, a wavelength variable light source is used, and the long-range sensor 10 controls the wavelength variable light source so that light signals of two wavelengths are emitted in a time-division manner as shown in FIG. 6.

Although the light signal propagates between the transmitter 12 and the receiver 13 located away from each other in Exemplary Embodiment 1, one transceiver 71 and a reflector 72 may be used as shown in FIG. 7. In such a case, the influence of optical axis deviation is reduced, and the number of power supply points is reduced.

### Exemplary Embodiment 2

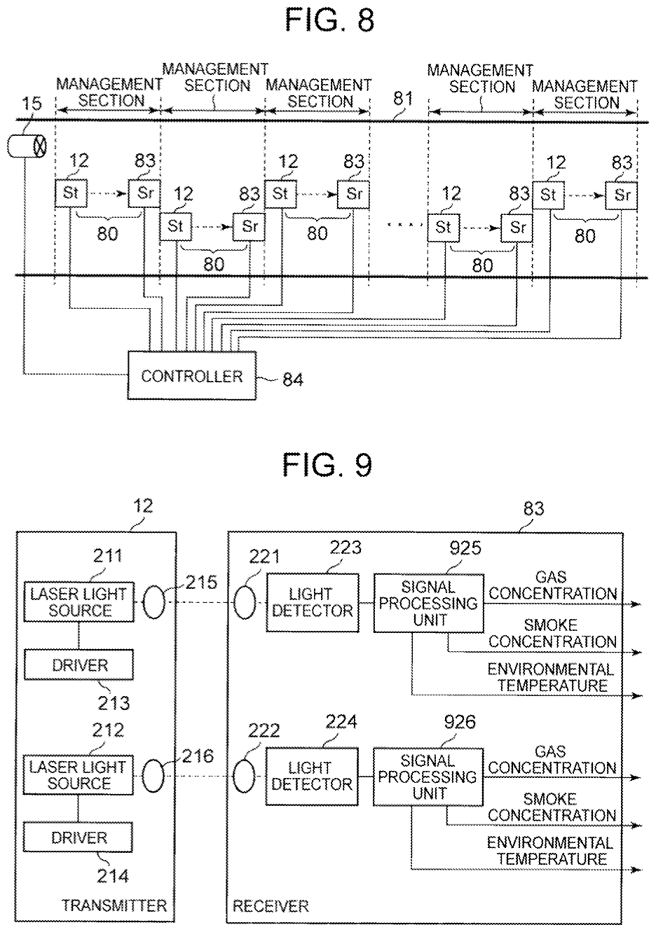

FIG. 8 is a block diagram depicting an example of an in-tunnel control system including a control system for use in a tunnel fire according to Exemplary Embodiment 2.

In Exemplary Embodiment 1, the monitoring camera 16 is used to identify the management section which includes the fire point. In Exemplary Embodiment 2, the fire point is identified using information obtained by a long-range sensor 80, without using the monitoring camera 16.

As in Exemplary Embodiment 1, a jet fan 15 is installed in a tunnel 81 shown in FIG. 8. The tunnel 81 is divided into a plurality of management sections. The long-range sensor 80 is installed in each management section. The long-range sensor 80 is composed of a transmitter 12 and a receiver 83 for light signals. The long-range sensor 80 is installed at an upper part of the side wall of the tunnel 81. A measurement value of each long-range sensor 80 is transmitted to a controller 84.

FIG. 9 is a block diagram depicting an example of the structure of the long-range sensor 80. In the example of the long-range sensor 80 shown in FIG. 9, the structure of the transmitter 12 is the same as that in Exemplary Embodiment 1. The receiver 83 includes two condensers 221 and 222, light detectors 223 and 224, and signal processing units 925 and 926.

In each of the long-range sensors 80 spaced at a predetermined distance inside the tunnel 11, the signal processing units 925 and 926 each calculate gas concentration, smoke concentration, and temperature (environmental temperature) in the management section where the long-range sensor 80 is installed, using the electrical signal from the corresponding one of the light detectors 223 and 224.

The operation of the long-range sensor 80 will be described below.

The signal processing units 925 and 926 measure the average space temperature between the transmitter 12 and the receiver 83, in addition to performing the gas concentration measurement and the smoke concentration measurement in Exemplary Embodiment 1.

The shape of an absorption spectrum of a gas molecule used when measuring gas concentration by WMS or DOAS varies depending on the environmental temperature, the atmospheric pressure, and the interaction with other gas molecules. Accordingly, the environmental temperature can be measured based on the received spectral intensity. In this exemplary embodiment, the signal processing units 925 and 926 measure the average value of temperature on the optical axis using two-line thermometry described in NPL 4, and set the average value of temperature as the environmental temperature. The method of measuring temperature using a technique employed when measuring gas concentration is not limited to two-line thermometry.

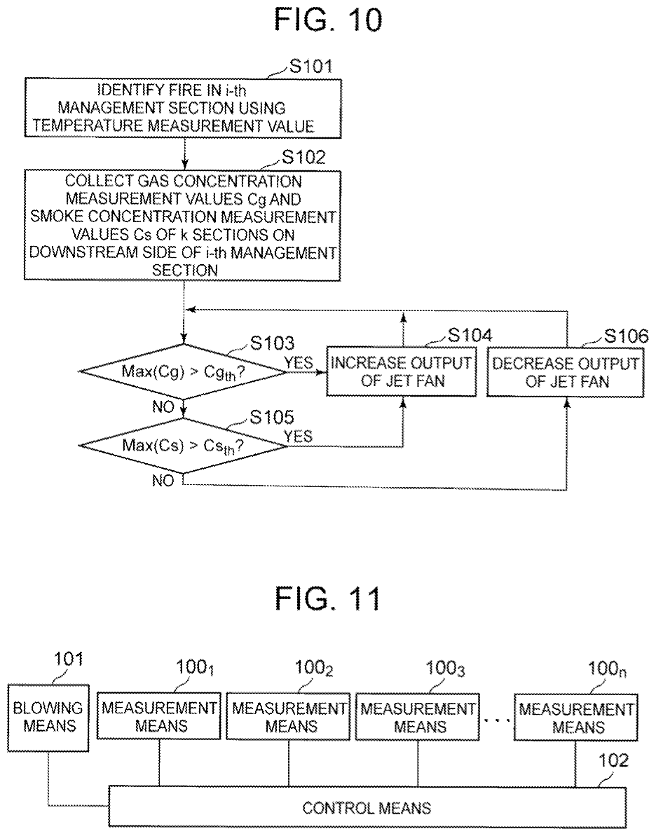

The operation of the controller 84 in Exemplary Embodiment 2 will be described below, with reference to a flowchart in FIG. 10.

The controller 84 identifies a management section i which includes a fire point, using the environmental temperature measured by the long-range sensor 80 (step S101). The temperature of gas generated by a fire is highest at the fire point. The gas is cooled as its distance from the fire point increases. The controller 84 can therefore determine that the fire point is present in the management section in which the higher environmental temperature than the environmental temperature measured by the long-range sensor 80 in each of its surrounding management sections is measured.

The controller 84 then performs the process in steps S102 to S106, as in Exemplary Embodiment 1.

According to Exemplary Embodiment 2, an in-tunnel control system for detecting a fire and controlling an equipment can be constructed at low cost, in addition to the effects according to Exemplary Embodiment 1. This is because, in Exemplary Embodiment 2, the controller 84 identifies the fire point using the environmental temperature measured by the long-range sensor 80, and thus the monitoring camera is unnecessary.

Although the laser light sources 211 and 212 are used as the two light sources in Exemplary Embodiment 2, broadband light sources such as LEDs or SLDs may be used. Moreover, the gas concentration may be measured by DOAS.

A light amplifier may be provided in the output stage of each of the laser light sources 211 and 212 and the input stage of each of the light detectors 223 and 224 in Exemplary Embodiment 2, too. The provision of the light amplifier improves the signal-to-noise ratio of the received light signal and improves the accuracy of the measurement result.

Although the structure in which the light signal propagates in one direction in the space between the transmitter 12 and the receiver 83 is used in Exemplary Embodiment 2, one or more mirrors may be provided between the transmitter 12 and the receiver 83. By causing the light signal to reflect off the one or more mirrors, the space propagation path of the light signal can be lengthened. As a result of lengthening the space propagation path of the light signal, target gas of lower concentration can be detected.

Although the two signal processing units 925 and 926 are provided to process light signals of two lines in Exemplary Embodiment 2, the signal processing units 925 and 926 may be integrated into one signal processing unit.

Although each of the light signals of two lines that differ in wavelength is used to measure the smoke concentration and the environmental temperature in Exemplary Embodiment 2, only the light signal of one line may be used. The controller 84 may use the average value of the smoke concentrations of the two lines and the average value of the environmental temperatures of the two lines, to improve the accuracy of the measurement values.

In Exemplary Embodiment 2, the kind of gas used in the environmental temperature measurement and the kind of gas used in the control of the jet fan 15 may be different. For example, normal CO concentration in the atmosphere is very low, i.e. about 1 [ppm], which is likely to hinder accurate environmental temperature measurement. On the other hand, normal CO₂ concentration in the atmosphere is high, i.e. about 400 [ppm], so that sufficient spectral intensity is observed. That is, more accurate environmental temperature measurement is possible in the case of using CO₂ concentration than in the case of using CO concentration. Hence, CO₂ gas and CO gas may be used respectively in the environmental temperature measurement and the control of the jet fan 15.

When using light signals of three or more lines that differ in wavelength, the controller 84 controls the air volume of the jet fan 15 based on one or both of the gas concentration and the smoke concentration obtained using at least one of the light signals of the plurality of lines different in wavelength from the light signal (the light signal used in the environmental temperature measurement) of the wavelength used to identify the management section which includes the fire point.

Although two different light sources are used to measure CO gas concentration and CO₂ gas concentration in Exemplary Embodiment 2, one light source may be used. In such a case, for example, light signals of two wavelengths are emitted from the light source in a time-division manner, as shown in FIG. 6.

Although the light signal propagates between the transmitter 12 and the receiver 83 located away from each other in Exemplary Embodiment 2, one transceiver 71 and a reflector 72 may be used as shown in FIG. 7. In such a case, the influence of optical axis deviation is reduced, and the number of power supply points is reduced.

FIG. 11 is a block diagram depicting main parts of a control system for use during a tunnel fire. The control system for use during a tunnel fire shown in FIG. 11 includes: measurement means 100₁ to 100ₙ (measurement unit: realized by the long-range sensor 10 or the long-range sensor 80 in the exemplary embodiments) installed in each of a plurality of management sections assigned in a tunnel, and for measuring one or both of a gas concentration and a smoke concentration in the management section using a light signal; and control means 102 (control unit: realized by the controller 14 or the controller 84 in the exemplary embodiments) for identifying a management section to which includes a fire point, and controlling an air volume of blowing means 101 (realized by the jet fan 15 in the exemplary embodiments) capable of changing an air volume in the tunnel, based on one or both of the gas concentration and the smoke concentration measured by one or more measurement means (e.g. the measurement means 100₃, or the measurement means 100₃ and the measurement means downstream of the measurement means 100₃) installed in one or more management sections located downstream of the identified management section (e.g. a management section including the measurement means 100₂).

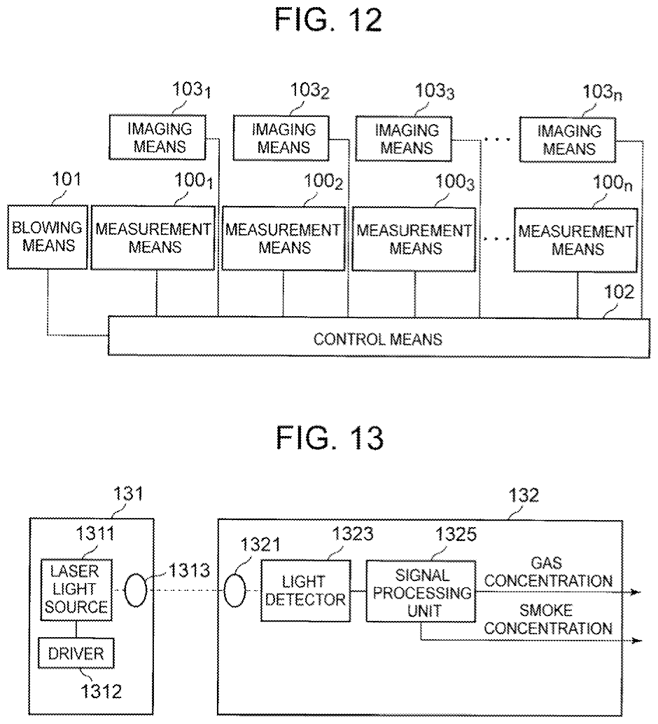

FIG. 12 is a block diagram depicting main parts of a control system for use during a tunnel fire according to another embodiment. The control system for use during a tunnel fire shown in FIG. 12 further includes imaging means 103₁ to 103ₙ (realized by the monitoring camera 16 in the exemplary embodiments) located in each of the plurality of management sections and for acquiring an image of the management section, wherein the control means 102 identifies the management section which includes the fire point, based on the image acquired by the imaging means 103₁ to 103ₙ.

The foregoing exemplary embodiments can be wholly or partly described as, but not limited to, the following supplementary notes.

(Supplementary note 1) A control system for use during a tunnel fire, comprising: measurement means installed in each of a plurality of management sections assigned in a tunnel, and for measuring one or both of a gas concentration and a smoke concentration in the management section using a light signal; and

control means for identifying a management section which includes a fire point, and controlling blowing means capable of changing an air volume, based on one or both of the gas concentration and the smoke concentration measured by one or more measurement means installed in one or more management sections located downstream of the identified management section.

(Supplementary note 2) The control system for use during a tunnel fire according to supplementary note 1, further comprising imaging means installed in each of the plurality of management sections, and for acquiring an image of the management section,

wherein the control means identifies the management section which includes the fire point, based on the image.

(Supplementary note 3) The control system for use during a tunnel fire according to supplementary note 1, wherein the measurement means has a temperature measurement function of measuring a temperature in a space in which the light signal propagates, and

wherein the control means identifies the management section which includes the fire point, based on the measured temperature.

(Supplementary note 4) The control system for use during a tunnel fire according to supplementary note 3, wherein the measurement means includes a light source for emitting light signals of different wavelengths, and

wherein the control means identifies the management section which includes the fire point, based on the temperature obtained using at least one of the light signals.

(Supplementary note 5) The control system for use during a tunnel fire according to supplementary note 4, wherein the control means controls the air volume of the blowing means, based on one or both of the gas concentration and the smoke concentration obtained using at least one of light signals of wavelengths different from a wavelength of the light signal used to identify the management section.

(Supplementary note 6) The control system for use during a tunnel fire according to supplementary note 4 or 5, wherein the measurement means emits the light signals of the different wavelengths, by changing an output wavelength of a wavelength variable light source in a time-division manner.

(Supplementary note 7) A control method for use during a tunnel fire, comprising: measuring, in each of a plurality of management sections assigned in a tunnel, one or both of a gas concentration and a smoke concentration in the management section using a light signal;

identifying a management section which includes a fire point; and

controlling blowing means capable of changing an air volume, based on one or both of the gas concentration and the smoke concentration measured in one or more management sections located downstream of the identified management section.

(Supplementary note 8) The control method for use during a tunnel fire according to supplementary note 7, wherein

the management section which includes the fire point is identified based on an image acquired by imaging means installed in each of the plurality of management sections and for acquiring an image of the management section.

(Supplementary note 9) The control method for use during a tunnel fire according to supplementary note 7, a temperature in a space in which the light signal propagates is measured, and

the management section which includes the fire point is identified based on the measured temperature.

(Supplementary note 10) The control method for use during a tunnel fire according to supplementary note 9, wherein

the management section which includes the fire point is identified based on the temperature obtained using at least one of light signals of different wavelengths.

(Supplementary note 11) The control method for use during a tunnel fire according to supplementary note 10, wherein

the air volume of the blowing means is controlled based on one or both of the gas concentration and the smoke concentration obtained using at least one of light signals of wavelengths different from a wavelength of the light signal used to identify the management section.

(Supplementary note 12) The control method for use during a tunnel fire according to supplementary note 10 or 11, wherein

the light signals of the different wavelengths are emitted by changing an output wavelength of a wavelength variable light source in a time-division manner.

Although the present invention has been described with reference to the exemplary embodiments, the present invention is not limited to the exemplary embodiments. Various changes understandable by those skilled in the art can be made to the structures and details of the present invention within the scope of the present invention.

This application claims priority based on Japanese Patent Application No. 2017-237849 filed on Dec. 12, 2017, the disclosure of which is incorporated herein in its entirety.

### REFERENCE SIGNS LIST

10, 80 long-range sensor
11, 81 tunnel
12 transmitter
13, 83 receiver
14, 84 controller
15 jet fan
16 monitoring camera
71 transceiver
72 reflector
211, 212 laser light source
213, 214 driver
215, 216, 221, 222 condenser
223, 224 light detector
225, 226, 925, 926 signal processing unit

1. A control system for use during a tunnel fire, comprising:
a measurement unit installed in each of a plurality of management sections assigned in a tunnel, and which measures one or both of a gas concentration and a smoke concentration in the management section using a light signal; and
a controller which identifies a management section which includes a fire point, and controls a blower capable of changing an air volume, based on one or both of the gas concentration and the smoke concentration measured by one or more measurement means installed in one or more management sections located downstream of the identified management section.

2. The control system for use during a tunnel fire according to claim 1, further comprising
an imaging unit installed in each of the plurality of management sections, and which acquires an image of the management section,
wherein the controller identifies the management section which includes the fire point, based on the image.

3. The control system for use during a tunnel fire according to claim 1, wherein the measurement unit has a temperature measurement function of measuring a temperature in a space in which the light signal propagates, and
wherein the controller identifies the management section which includes the fire point, based on the measured temperature.

4. The control system for use during a tunnel fire according to claim 3, wherein the measurement unit includes a light source for emitting light signals of different wavelengths, and
wherein the controller identifies the management section which includes the fire point, based on the temperature obtained using at least one of the light signals.

5. The control system for use during a tunnel fire according to claim 4, wherein the controller controls the air volume of the blower, based on one or both of the gas concentration and the smoke concentration obtained using at least one of light signals of wavelengths different from a wavelength of the light signal used to identify the management section.

6. The control system for use during a tunnel fire according to claim 4, wherein the measurement unit emits the light signals of the different wavelengths, by changing an output wavelength of a wavelength variable light source in a time-division manner.

7. A control method for use during a tunnel fire, comprising:
measuring, in each of a plurality of management sections assigned in a tunnel, one or both of a gas concentration and a smoke concentration in the management section using a light signal;
identifying a management section which includes a fire point; and
controlling a blower capable of changing an air volume, based on one or both of the gas concentration and the smoke concentration measured in one or more management sections located downstream of the identified management section.

8. The control method for use during a tunnel fire according to claim 7, wherein
the management section which includes the fire point is identified based on an image acquired by an imaging unit installed in each of the plurality of management sections and for acquiring an image of the management section.

9. The control method for use during a tunnel fire according to claim 7, wherein
a temperature in a space in which the light signal propagates is measured, and
the management section which includes the fire point is identified based on the measured temperature.

10. The control method for use during a tunnel fire according to claim 9, wherein
the management section which includes the fire point is identified based on the temperature obtained using at least one of light signals of different wavelengths.

11. The control method for use during a tunnel fire according to claim 10, wherein
the air volume of the blower is controlled based on one or both of the gas concentration and the smoke concentration obtained using at least one of light signals of wavelengths different from a wavelength of the light signal used to identify the management section.

12. The control method for use during a tunnel fire according to claim 10, wherein
the light signals of the different wavelengths are emitted by changing an output wavelength of a wavelength variable light source in a time-division manner.

13. The control system for use during a tunnel fire according to claim 5, wherein the measurement unit emits the light signals of the different wavelengths, by changing an output wavelength of a wavelength variable light source in a time-division manner.

14. The control method for use during a tunnel fire according to claim 11, wherein
the light signals of the different wavelengths are emitted by changing an output wavelength of a wavelength variable light source in a time-division manner.
